(19) United States
(12) Patent Application Publication
(10) Pub. No.: US 2019/0140386 A1
(43) Pub. Date: May 9, 2019

(54) INLINE CONNECTOR TPA TERMINAL STABILIZER

(71) Applicant: GM GLOBAL TECHNOLOGY OPERATIONS LLC, Detroit, MI (US)

(72) Inventors: Christopher Dillon, Clarkston, MI (US); Brian Scigiel, Keego Harbor, MI (US)

(73) Assignee: GM GLOBAL TECHNOLOGY OPERATIONS LLC, Detroit, MI (US)

(21) Appl. No.: 15/806,799

(22) Filed: Nov. 8, 2017

(51) Int. Cl. H01R 13/436

(52) U.S. Cl. CPC H01R 13/4361; H01R 2201/26

(57) ABSTRACT

In various embodiments, assemblies, systems and vehicles are provided. In various embodiments, a connector assembly system is disposed within a vehicle body, and includes an electrical terminal, a housing, and a terminal position assurance (TPA) device. The housing includes one or more walls forming a cavity disposed within the housing and configured to allow passage therethrough. The TPA device includes one or more bodies configured to be disposed within the cavity while the terminal is also disposed within the cavity. The one or more bodies are configured to reduce a clearance for the terminal at a plurality of different directions when the TPA device and the terminal are disposed within the cavity, to thereby inhibit unwanted movement of the terminal within the housing.

### TECHNICAL FIELD

The technical field generally relates to the field of vehicles and, more specifically, to devices and systems for stabilizing terminals inside inline electrical connectors, for example for use in vehicles.

### INTRODUCTION

Many vehicles today include systems with inline electrical connectors. However, in certain situations, terminals of the electrical connectors may experience or other unwanted movement, which may lead, for example, to bent, damaged, or misaligned terminals.

Accordingly, it is desirable to provide devices and systems for stabilizing the terminals inside the inline electrical connectors, for example for use in vehicles. Furthermore, other desirable features and characteristics will become apparent from the subsequent detailed description and the appended claims, taken in conjunction with the accompanying drawings.

### SUMMARY

In various embodiments, a connector assembly is provided. In various embodiments, the connector assembly includes a housing and a terminal position assurance (TPA) device. The housing includes one or more walls forming a cavity disposed within the housing and configured to allow passage therethrough. The TPA device includes one or more bodies configured to be disposed within the cavity while a terminal is also disposed within the cavity. The one or more bodies are configured to reduce a clearance for the terminal at a plurality of different directions when the TPA device and the terminal are disposed within the cavity, to thereby inhibit unwanted movement of the terminal within the housing.

Also in various embodiments, the one or more bodies of the TPA device are configured to reduce a clearance for the terminal at the plurality of different directions that are substantially perpendicular to one another.

Also in various embodiments, at least one body of the TPA device includes a unitary piece that is configured to reduce a clearance for the terminal at a first direction, against a top of the terminal, and at a second direction, against a side of the terminal, when the TPA device and the terminal body are disposed within the cavity, to thereby inhibit unwanted movement of the terminal within the housing.

Also in various embodiments, the one or more bodies: provide a stop for the terminal against further lateral movement of the terminal body in the second direction; and reduce a clearance for the terminal in the first direction that inhibits vertical movement of the terminal.

Also in various embodiments, the cavity is disposed within a lateral side of the housing, to allow entry of the TPA device and the terminal from the lateral side.

Also in various embodiments, the cavity is disposed within a top of the housing, to allow entry of the TPA device and the terminal from the top of the housing.

Also in various embodiments, the cavity is disposed within a bottom of the housing, to allow entry of the TPA and the terminal from the bottom of the housing.

In various embodiments, a connector assembly includes an electrical terminal, a housing, and a terminal position assurance (TPA) device. The housing includes one or more walls forming a cavity disposed within the housing and configured to allow passage therethrough. The TPA device includes one or more bodies configured to be disposed within the cavity while the terminal is also disposed within the cavity. The one or more bodies are configured to reduce a clearance for the terminal at a plurality of different directions when the TPA device and the terminal are disposed within the cavity, to thereby inhibit unwanted movement of the terminal within the housing.

Also in various embodiments, the one or more bodies of the TPA device are configured to reduce a clearance for the terminal at the plurality of different directions that are substantially perpendicular to one another.

Also in various embodiments, the one or more bodies of the TPA device are configured to reduce a clearance for the terminal at the plurality of different directions that are substantially perpendicular to one another.

Also in various embodiments, at least one body of the TPA device includes a unitary piece that is configured to reduce a clearance for the terminal at a first direction, against a top of the terminal, and at a second direction, against a side of the terminal, when the TPA device and the terminal are disposed within the cavity, to thereby inhibit unwanted movement of the terminal inside the housing.

Also in various embodiments, the cavity is disposed within a lateral side of the housing, to allow entry of the TPA device and the terminal from the lateral side.

Also in various embodiments, the cavity is disposed within a top of the housing, to allow entry of the TPA device and the terminal from the top of the housing.

Also in various embodiments, the cavity is disposed within a bottom of the housing, to allow entry of the TPA device and the terminal from the bottom of the housing.

In various embodiments, a vehicle is provided. The vehicle includes a vehicle body and a connector assembly system. The connector assembly system is disposed within the vehicle body, and includes an electrical terminal, a housing, and a terminal position assurance (TPA) device. The housing includes one or more walls forming a cavity disposed within the housing and configured to allow passage therethrough. The TPA device includes one or more bodies configured to be disposed within the cavity while the terminal is also disposed within the cavity. The one or more bodies are configured to reduce a clearance for the terminal at a plurality of different directions when the TPA device and the terminal are disposed within the cavity, to thereby inhibit unwanted movement of the terminal within the housing.

Also in various embodiments, the one or more bodies of the TPA device are configured to reduce a clearance for the terminal at the plurality of different directions that are substantially perpendicular to one another.

Also in various embodiments, at least one body of the TPA device comprises a unitary piece that is configured to reduce a clearance for the terminal at a first direction, against a top of the terminal, and at a second direction, against a side of the terminal, when the TPA device and the terminal are disposed within the cavity, to thereby inhibit unwanted movement of the terminal within the housing.

Also in various embodiments, the one or more bodies: provide a stop for the terminal against further lateral movement of the terminal in the second direction; and reduce a clearance for the terminal in the first direction that inhibits vertical movement of the terminal.

Also in various embodiments, the cavity is disposed within a lateral side of the housing, to allow entry of the TPA device and the terminal from the lateral side.

Also in various embodiments, the cavity is disposed within a top or bottom of the housing, to allow entry of the TPA device and the terminal from the top or bottom of the housing.

Also in various embodiments, the tightened fit of the TPA device around the terminal results in a rejection of terminals that do not meet an intended terminal geometry, comprising one or more of the following: (i) the TPA device not seating fully or seating partially; (ii) the TPA device requiring excessive force; or (iii) the terminal being forced out of the cavity.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes an electrical connection system with a connector housing and a terminal position assurance (TPA) device that secures a terminal with multiple directions of reduced clearance (e.g., contact), in accordance with exemplary embodiments;

FIG. 2 is a schematic diagram of an electrical connection system such as the electrical connection system of FIG. 1, depicted with the TPA device outside the connector housing, and that can be implemented in connection with the vehicle of FIG. 1, in accordance with exemplary embodiments;

FIG. 3 is a schematic diagram of a first example of an electrical connection system such as the electrical connection system of FIGS. 1 and 2, in which the TPA device is side loaded into the connector housing, and depicted with the TPA device inside the connector housing, and that can be implemented in connection with the vehicle of FIG. 1, in accordance with exemplary embodiments;

FIG. 4 is a schematic diagram of a second example of an electrical connection system such as the electrical connection system of FIGS. 1 and 2, in which the TPA device is top loaded into the connector housing, and depicted with the TPA device inside the connector housing, and that can be implemented in connection with the vehicle of FIG. 1, in accordance with exemplary embodiments; and

FIG. 5 is a schematic diagram of a third example of an electrical connection system such as the electrical connection system of FIGS. 1 and 2, in which the TPA device is front loaded into the connector housing, and depicted with the TPA device inside the connector housing, and that can be implemented in connection with the vehicle of FIG. 1, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

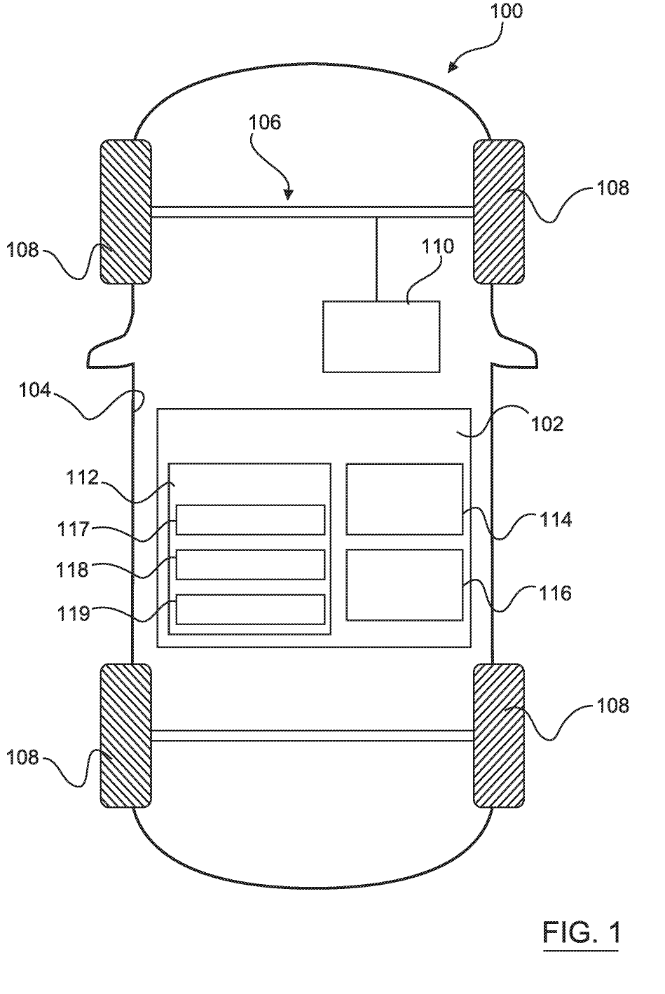

FIG. 1 illustrates a vehicle 100, according to an exemplary embodiment. As described in greater detail further below, the vehicle 100 includes an electrical connection system 102.

In various embodiments, the vehicle 100 comprises an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise a motorcycle or other vehicle, or other system having a camera image with a fixed referenced point.

In various embodiments, the vehicle 100 includes a body 104 that is arranged on a chassis 106. The body 104 substantially encloses other components of the vehicle 100. The body 104 and the chassis 106 may jointly form a frame. The vehicle 100 also includes a plurality of wheels 108. The wheels 108 are each rotationally coupled to the chassis 106 near a respective corner of the body 104 to facilitate movement of the vehicle 100. In one embodiment, the vehicle 100 includes four wheels 108, although this may vary in other embodiments (for example for trucks and certain other vehicles).

A drive system 110 is mounted on the chassis 106, and drives the wheels 108. The drive system 110 preferably comprises a propulsion system. In certain exemplary embodiments, the drive system 110 comprises an internal combustion engine and/or an electric motor/generator, coupled with a transmission thereof. In certain embodiments, the drive system 110 may vary, and/or two or more drive systems 110 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

In various embodiments, the vehicle 100 may include any number of electrical connection systems 102. In various embodiments, each electrical connection system 102 comprises an inline electrical connection system. Also in various embodiments, each electrical connection system 102 comprises or is part of or coupled to one or more vehicle devices and/or systems, such as a vehicle headlight system, engine control system, alternator system, infotainment and/or speaker system, and/or any number of other different types of vehicle devices and/or systems.

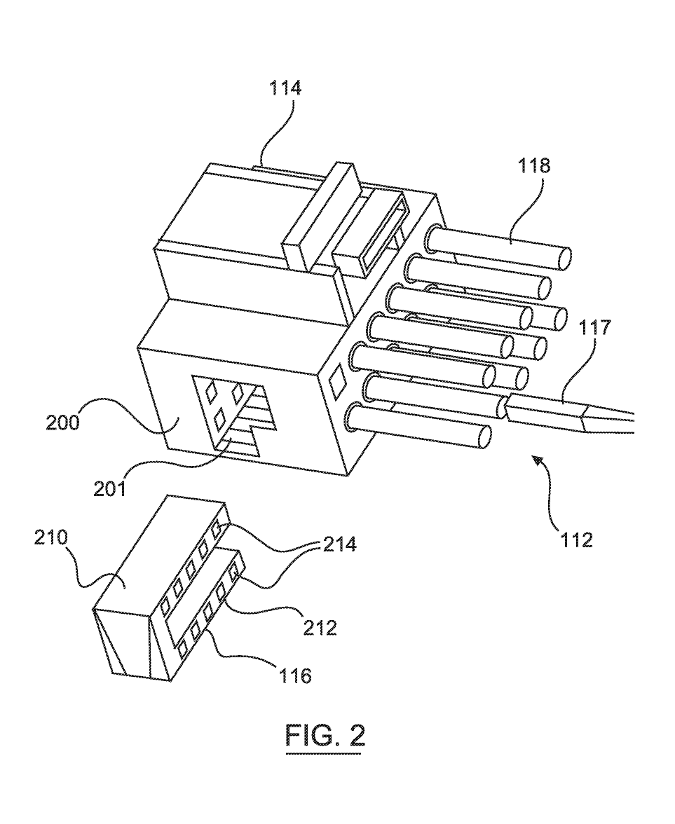

As depicted in FIG. 1, in various embodiments the electrical connection system 102 includes one or more terminals 112, a connector housing 114, and one or more terminal position assurance (TPA) devices 116. Also in various embodiments, each terminal 112 includes a terminal lead 117, a terminal body 118, and a blade tip 119. In addition, in various embodiments, the TPA devices 116 are configured to be inserted into a cavity of the connector housing 114. In various embodiments, the TPA devices 116 reduce a clearance for the terminals 112 at multiple different locations and directions, to thereby inhibit unwanted movement of the terminals 112 within the connector housing 114, for example as depicted in FIGS. 2-5 and described in greater detail further below in connection therewith. In certain embodiments, the connector housing 114 also reduced clearance for provides additional reduced clearance for the terminals 112, for example as is also depicted in FIGS. 2-5 and described in greater detail further below in connection therewith.

As used throughout this Application, the terms “reduce clearance”, “reduced clearance”, and variations thereof refer to a reduced clearance (e.g., for movement) around the terminals 112. In certain embodiments, such a reduced clearance refers to physical contact between the terminal 112 and one or more other surfaces. Alternatively, in certain other embodiments, such a reduced clearance may refer to a close proximity between the terminal 112 and the one or more other surfaces, and/or an interference (e.g., a slight interference) between the terminal 112 and the one or more other surfaces, and/or one or more other techniques for attaining a reduced clearance for the terminal 112.

FIG. 2 is a schematic diagram of an electrical connection system 102, in accordance with various embodiments. Also in various embodiments, the electrical connection system 102 of FIG. 2 corresponds to the electrical connection system 102 of FIG. 1 (e.g., including terminals 112, a connector housing 114, TPA devices 116, terminal leads 117, terminal bodies 118, and blade tips 119 as discussed above in connection with FIG. 1), and can be implemented in connection with the vehicle 100 of FIG. 1. In various embodiments, the electrical connection system 102 of FIG. 1 can also be implemented in any number of other devices that include an inline electrical connection system. In FIG. 2, the TPA device 116 is depicted outside the connector housing 114.

In the depicted example, the connector housing 114 includes a wall 200 forming a cavity 201 for passage of the TPA device 116 and terminals 112 therethrough in various embodiments. Also in various embodiments, once the TPA device 116 and the terminal bodies 118 are disposed within the cavity 201 of the connector housing 114, the TPA device 116 reduces clearance for each of the terminal bodies 118 at multiple different directions, to thereby inhibit unwanted movement of the terminals 112 within the connector housing 114. In addition, in certain embodiments, the connector housing 114 also reduces clearance for each of the terminal bodies 118, to thereby inhibit unwanted movement of the terminals 112 within the connector housing 114.

Also as depicted in FIG. 2, in certain embodiments, each TPA device 116 includes an upper body 210, a lower body 212, and a plurality of openings 214 in between. Also in various embodiments, a plurality of terminals 112 slide within the openings 214 when the TPA device 116 and the terminal bodies 118 are disposed within the cavity 201. In various embodiments, the upper body 210 and the lower body 212 both comprise bodies that reduce a clearance for the terminal bodies 118 when disposed within the cavity 201, to inhibit unwanted movement of the terminals 112 within the housing 114. Also in certain embodiments the TPA device 116 is made of a unitary piece; however, this may vary in other embodiments.

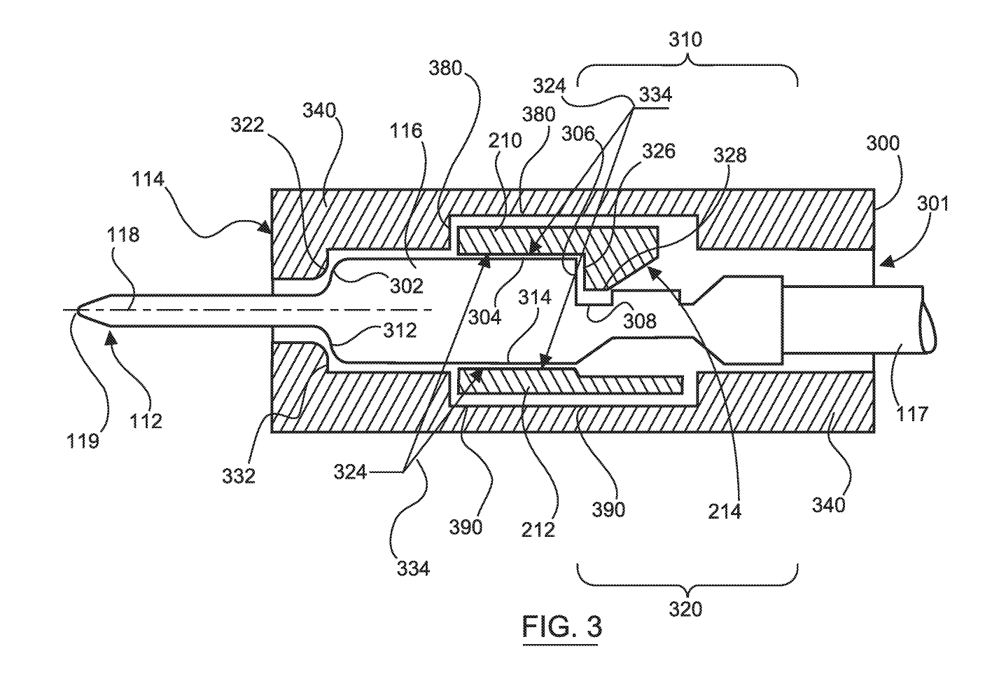

Various embodiments of the electrical connection system 102 are depicted in greater detail in FIGS. 3-5 as implemented within the connector housing 114, and are discussed in greater detail below in connection therewith. In each of the examples of FIGS. 3-5, the connector housing includes a wall forming a cavity for passage of the TPA device 116 and terminals 112 therethrough. Also in each of the examples, the TPA device 116 and the terminals 112 are disposed within the cavity, and the TPA device 116 reduces clearance for each of the terminals 112 at a plurality of different locations and directions, to thereby inhibit unwanted movement of the electrical terminal 112 within the connector housing 114, for example as described in greater detail below in connection with FIGS. 3-5.

FIG. 3 is a schematic diagram of a first example of an electrical connection system 102, such as the electrical connection system 102 of FIGS. 1 and 2, in accordance with exemplary embodiments. In the example of FIG. 3, the connector housing 114 includes a wall 300 that forms a cavity 301 on a lateral side of the connector housing 114. The TPA 116 and the terminal 112 are configured to slide through the cavity 301 on the lateral side of the connector housing 114, to thereby enter inside the connector housing 114. The TPA device 116 and the terminal 112 are depicted as inserted into the cavity 301 (i.e., the TPA device 116 and the terminal 112 are disposed inside the connector housing 114) in FIG. 3.

In various embodiments, the TPA device 116 includes an upper body 210 and a lower body 212 that provide reduce a clearance for the terminal 112 at different directions when the TPA device 116 and the terminal 112 are inserted into the cavity 301, to thereby inhibit unwanted movement of the electrical terminal 112 within the connector housing 114. Specifically, as shown in FIG. 3 and discussed in greater detail below, in various embodiments one or more respective upper or lower bodies 210, 212 of the TPA device 116 are configured to reduce a clearance for the terminal 112 (specifically, in certain embodiments, the terminal body 118 thereof) at a plurality of different directions that are substantially perpendicular to one another (e.g., a vertical direction against a lateral side of the electrical terminal 112 and a horizontal direction against a top of the electrical terminal 112), in order to provide stops for the electrical terminal 112 in multiple directions and stability for the electrical terminal 112 against movement. Also as depicted in FIG. 3, in various embodiments the upper body 210 and the lower body 212 of the TPA 116 are held in place by respective upper walls 380 and lower walls 390, respectively, of the base housing 340 that surround and are shaped in approximately the same manner as the upper body 210 and the lower body 210, respectively, of the TPA device 116, as shown in FIG. 3.

As depicted in FIG. 3, in various embodiments the terminal body 118 of the electrical terminal 112 includes: (i) a first top section 302 that includes an upper surface that extends substantially upward (e.g., substantially vertically, in some embodiments) from a covered portion of the terminal body 118; (ii) a second top section 304 that includes an upper surface that extends horizontally from the first top section 302 as a top surface of the terminal body 118 (in certain embodiments, the second top section 304 is substantially perpendicular to the first top section 302); (iii) a third top section 306 that includes an upper surface that extends vertically/downward from the second top section 304 along a lateral side of the terminal body 118; (iv) a fourth top section 308 that includes an upper surface that extends horizontally from the third top section 306; (v) a fifth top section 310 that includes an upper surface that extends from the fourth top section 308 toward the terminal lead 117 in a varied pattern to facilitate movement and/or locking within the connector housing 114; (vi) a first bottom section 312 that includes a lower surface that extends substantially downward (e.g., substantially vertically, in some embodiments) from a portion of the terminal body 118; (vii) a second bottom section 314 that includes a lower surface that extends horizontally from the first bottom section 312 as a bottom surface of the terminal body 118; and (viii) a third bottom section 320 that includes a lower surface that extends from the second bottom section 314 toward the terminal lead 117 in a varied pattern to facilitate movement and/or locking within the connector housing 114.

In various embodiments, the bodies 210, 212 of the TPA device 116 provide reduce a clearance for the terminal 112 (namely, in various embodiments, the terminal body 118 thereof) at various different locations and directions, to thereby inhibit movement of the electrical terminal 112 within the cavity 301 (i.e., to thereby inhibit movement of the electrical terminal 112 within the connector housing 114). In certain embodiments, the base housing 340 provides further points of reduced clearance for reduced clearance for the terminal 112, to further inhibit movement of the terminal 112 within the cavity 301.

Specifically, in various embodiments, the base housing 340 of FIG. 3 includes a front top surface 322 and a front bottom surface 332. The front top surface 322 of the base housing 340 extends substantially upward, and is aligned with and parallel to the terminal body first top section 302. Also in various embodiments, the front top surface 322 of the base housing 340 reduces clearance for (and preferably reduces clearance for the entire upper surface of) the terminal body first top section 302.

In addition, in various embodiments, the front bottom surface 332 of the base housing 340 extends substantially downward, and is aligned with and parallel to the terminal body first bottom section 312. Also in various embodiments, the front bottom surface 332 of the base housing 340 reduces clearance for (and preferably reduces clearance for the entire lower surface of) the terminal body first bottom section 312.

In addition, in various embodiments, the upper body 210 includes a first surface 324, a second surface 326, and a third surface 328. In various embodiments, the first surface 324 of the upper body 210 extends horizontally, and is aligned with and parallel to the terminal body second top section 304. Also in various embodiments, the first surface 324 reduces clearance for (and preferably reduces clearance for the entire upper surface of) the terminal body second top section 304.

In various embodiments, the second surface 326 of the upper body 210 extends substantially downward (e.g., vertically, and perpendicular to the first surface 324), and is aligned with and parallel to the terminal body third top section 306. Also in various embodiments, the second surface 326 reduces clearance for (and preferably reduces clearance for the entire upper surface of) the terminal body third top section 306.

In various embodiments, the third surface 328 of the upper body 210 extends substantially horizontally (and perpendicular to the second surface 326), and is aligned with and parallel to the terminal body fourth top section 308. Also in various embodiments, the third surface 328 reduces clearance for (and preferably reduces clearance for the entire upper surface of) the terminal body fourth top section 308.

In addition, in various embodiments, the lower body 212 includes a surface 334. In various embodiments, the surface 334 of the lower body 212 extends horizontally, and is aligned with and parallel to the terminal body second bottom section 314. Also in various embodiments, the surface 334 reduces clearance for (and preferably reduces clearance for the entire upper surface of) the terminal body second bottom section 314.

Accordingly, in various embodiments, with the exemplary implementation of the electrical connection system 102 as illustrated in FIG. 3, the TPA device 116 provides reduced clearance for reduced clearance for the electrical terminal 112 (i.e., against the terminal body 118 thereof) at multiple different locations, in multiple different directions, to inhibit unwanted movement of the electrical terminal 112 within the connector housing 114. For example, as depicted in FIG. 3, the upper body 210 provides: (i) horizontal reduced clearance for reduced clearance for the terminal body 118 via first surface 324, (ii) adjoining vertical reduced clearance for reduced clearance for the terminal body 118 via second surface 326; and (iii) and adjoining horizontal reduced clearance for the terminal body 118 via third surface 328. In addition, the lower body 212 provides additional horizontal reduced clearance for the terminal body 118 via surface 334. Moreover, the base housing 340 provides additional upward reduced clearance (e.g., contact) (in certain embodiments, substantially vertical contact or other reduced clearance) with the terminal body 118 via the base housing front top surface 322, as well as additional downward reduced clearance (e.g., contact) (in certain embodiments, substantially vertical contact or other reduced clearance) with the terminal body 118 via the base housing front bottom 332.

Also in certain embodiments, the upper body 210 comprises a unitary piece that is configured to reduce a clearance for the terminal body 118 at multiple adjoining, perpendicular directions, including: (i) a first horizontal direction via surface 324; (ii) a second, adjoining vertical direction via surface 326; and (iii) a third, adjoining horizontal direction via surface 328, as depicted in FIG. 3.

In various embodiments, when the electrical terminal 112 is inserted into the connector, the TPA device 116 does not interfere with the electrical terminal 112. In various embodiments, this allows the electrical terminal 112 to insert into the cavity 301 at a low force. In various embodiments, this may be needed so that the wires do not buckle during terminal insertion. In various embodiments, after the electrical terminal is inserted, seating the TPA device 116 creates a tight fit around the electrical terminal 112. Also in various embodiments, by tightening the fit, the TPA device 116 reduces or eliminates the clearance around the electrical terminal 112 once the TPA device 116 is seated in the final position (e.g., as shown in the Drawings).

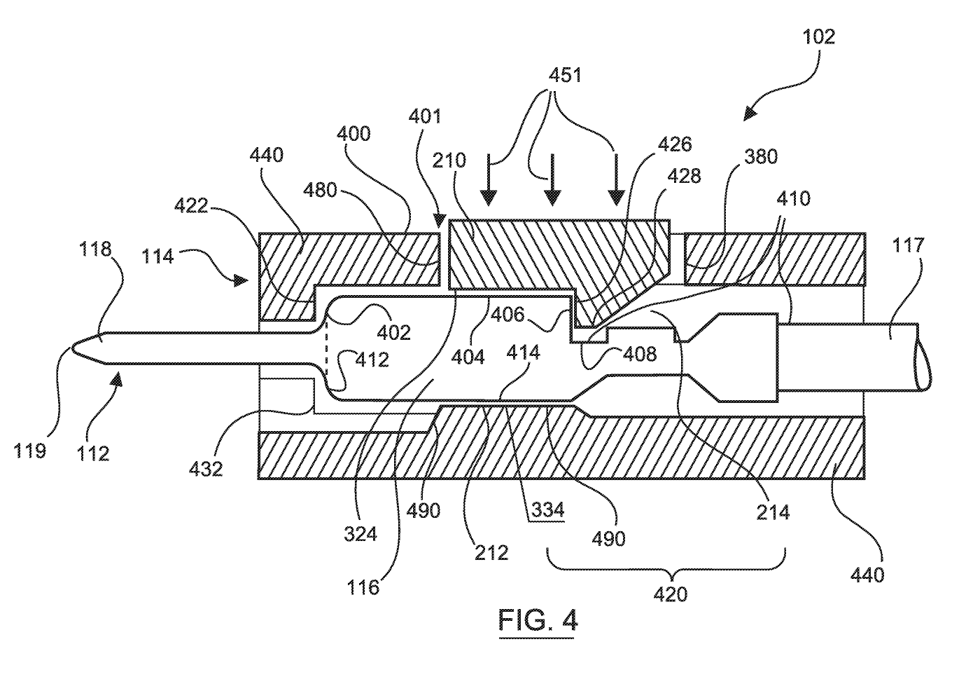

FIG. 4 is a schematic diagram of a second example of an electrical connection system 102, such as the electrical connection system 102 of FIGS. 1 and 2, in accordance with exemplary embodiments. In the example of FIG. 4, the connector housing 114 includes a wall 400 that forms a cavity 401 on a top portion of the connector housing 114. The TPA 116 and the electrical terminal 112 are configured to slide through the cavity 401 on the top side of the connector housing 114 via direction 451. The TPA device 116 and the terminal 112 are depicted as inserted into the cavity 401 (i.e., the TPA device 116 and the terminal 112 are disposed inside the connector housing 114) in FIG. 4.

In various embodiments, the TPA device 116 includes an upper body 210 and a lower body 212 that provide reduced clearance for the terminal 112 at different directions when the TPA device 116 and the terminal 112 are inserted into the cavity 401, to thereby inhibit unwanted movement of the electrical terminal 112 within the connector housing 114. Specifically, as shown in FIG. 4 and discussed in greater detail below, in various embodiments one or more respective upper or lower bodies 210, 212 of the TPA device 116 are configured to reduce a clearance for the terminal 112 (specifically, in certain embodiments, the terminal body 118 thereof) at a plurality of different directions that are substantially perpendicular to one another (e.g., a vertical direction against a lateral side of the electrical terminal 112 and a horizontal direction against a top of the electrical terminal 112), in order to provide stops for the electrical terminal 112 (e.g., for the terminal body 118) in multiple directions and stability for the electrical terminal 112 against movement. Also as depicted in FIG. 4, in various embodiments the upper body 210 and the lower body 212 of the TPA 116 are held in place by respective upper walls 480 and lower walls 490, respectively, of the base housing 440 that surround and are shaped in approximately the same manner as the upper body 210 and the lower body 210, respectively, of the TPA device 116, as shown in FIG. 4.

As depicted in FIG. 4, in various embodiments (and similar to the example of FIG. 3), the terminal body 118 of the electrical terminal 112 includes: (i) a first top section 402 that includes an upper surface that extends substantially upward (e.g., substantially vertically, in some embodiments) from a portion of the terminal body 118; (ii) a second top section 404 that includes an upper surface that extends horizontally from the first top section 402 as a top surface of the terminal body 118 (in certain embodiments, the second top section 404 is substantially perpendicular to the first top section 402); (iii) a third top section 406 that includes an upper surface that extends vertically/downward from the second top section 404 along a lateral side of the terminal body 118; (iv) a fourth top section 408 that includes an upper surface that extends horizontally from the third top section 406; (v) a fifth top section 410 that includes an upper surface that extends from the fourth top section 408 toward the terminal lead 117 in a varied pattern to facilitate movement and/or locking within the connector housing 114; (vi) a first bottom section 412 that includes a lower surface that extends substantially downward (e.g., substantially vertically, in some embodiments) from a portion of the terminal body 118; (vii) a second bottom section 414 that includes a lower surface that extends horizontally from the first bottom section 412 as a bottom surface of the terminal body 118; and (viii) a third bottom section 420 that includes a lower surface that extends from the second bottom section 414 toward the terminal lead 117 in a varied pattern to facilitate movement and/or locking within the connector housing 114.

In various embodiments, the bodies 210, 212 of the TPA device 116 provide reduce a clearance for the terminal 112 (namely, in various embodiments, the terminal body 118 thereof) at various different locations and directions, to thereby inhibit movement of the electrical terminal 112 within the cavity 401 (i.e., to thereby inhibit movement of the electrical terminal 112 within the connector housing 114). In certain embodiments, the base housing 440 provides further points of reduced clearance for the terminal 112, to further inhibit movement of the terminal 112 within the cavity 401.

Specifically, in various embodiments, the base housing 440 of FIG. 4 includes a front top surface 422 and a front bottom surface 432. The front top surface 422 of the base housing 440 extends substantially upward, and is aligned with and parallel to the terminal body first top section 402. Also in various embodiments, the front top surface 422 of the base housing 440 reduces clearance for (and preferably reduces clearance for the entire upper surface of) the terminal body first top section 402.

In addition, in various embodiments, the front bottom surface 432 of the base housing 440 extends substantially downward, and is aligned with and parallel to the terminal body first bottom section 412. Also in various embodiments, the front bottom surface 432 of the base housing 440 reduces clearance for (and preferably reduces clearance for the entire lower surface of) the terminal body first bottom section 412.

In addition, in various embodiments, the upper body 210 includes a first surface 424, a second surface 426, and a third surface 428. In various embodiments, the first surface 424 of the upper body 210 extends horizontally, and is aligned with and parallel to the terminal body second top section 404. Also in various embodiments, the first surface 424 reduces clearance for (and preferably reduces clearance for the entire upper surface of) the terminal body second top section 404.

In various embodiments, the second surface 426 of the upper body 210 extends substantially downward (e.g., vertically, and perpendicular to the first surface 424), and is aligned with and parallel to the terminal body third top section 406. Also in various embodiments, the second surface 426 reduces clearance for (and preferably reduces clearance for the entire upper surface of) the terminal body third top section 406.

In various embodiments, the third surface 428 of the upper body 210 extends substantially horizontally (and perpendicular to the second surface 426), and is aligned with and parallel to the terminal body fourth top section 408. Also in various embodiments, the third surface 428 reduces clearance for (and preferably reduces clearance for the entire upper surface of) the terminal body fourth top section 408.

In addition, in various embodiments, the lower body 212 includes a surface 434. In various embodiments, the surface 434 of the lower body 212 extends horizontally, and is aligned with and parallel to the terminal body second bottom section 414. Also in various embodiments, the surface 434 reduces clearance for (and preferably reduces clearance for the entire upper surface of) the terminal body second bottom section 414.

Accordingly, in various embodiments, with the exemplary implementation of the electrical connection system 102 as illustrated in FIG. 4, the TPA device 116 provides reduced clearance for the electrical terminal 112 (i.e., the terminal body 118 thereof) at multiple different locations, in multiple different directions, to inhibit unwanted movement of the electrical terminal 112 within the connector housing 114. For example, as depicted in FIG. 4, the upper body 210 provides: (i) horizontal reduced clearance for the terminal body 118 via first surface 424, (ii) adjoining vertical reduced clearance for the terminal body 118 via second surface 426; and (iii) and adjoining horizontal reduced clearance for the terminal body 118 via third surface 428. In addition, the lower body 212 provides additional horizontal reduced clearance for the terminal body 118 via surface 434. Moreover, the base housing 440 provides additional upward contact or other reduced clearance (in certain embodiments, substantially vertical contact or other reduced clearance) with the terminal body 118 via the base housing front top surface 422, as well as additional downward contact (in certain embodiments, substantially vertical contact or other reduced clearance) with the terminal body 118 via the base housing front bottom surface 432.

Also in certain embodiments, the upper body 210 comprises a unitary piece that is configured to reduce a clearance for the terminal body 118 at multiple adjoining, perpendicular directions, including: (i) a first horizontal direction via surface 424; (ii) a second, adjoining vertical direction via surface 426; and (iii) a third, adjoining horizontal direction via surface 428, as depicted in FIG. 4.

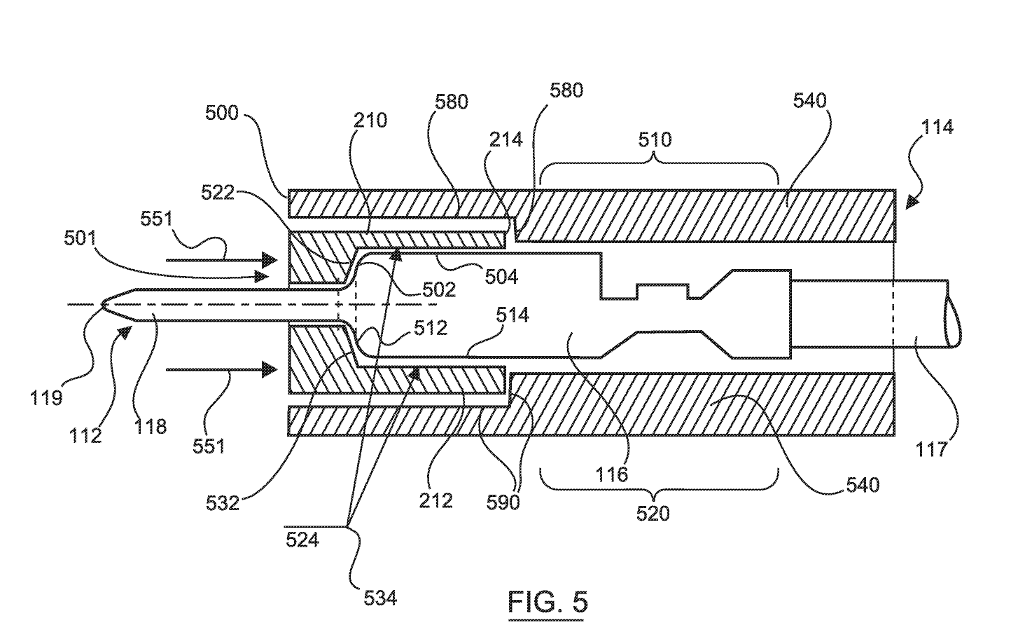

FIG. 5 is a schematic diagram of a third example of an electrical connection system 102, such as the electrical connection system 102 of FIGS. 1 and 2, in accordance with exemplary embodiments. In the example of FIG. 5, the connector housing 114 includes a wall 500 that forms a cavity 501 on a front side of the connector housing 114. The TPA 116 and the terminal 112 are configured to slide through the cavity 501 on the front side of the connector housing 114 via direction 551. The TPA device 116 and the terminal 112 are depicted as inserted into the cavity 501 (i.e., the TPA device 116 and the terminal 112 are disposed inside the connector housing 114) in FIG. 5.

In various embodiments, the TPA device 116 includes an upper body 210 and a lower body 212 that provide reduce a clearance for the terminal 112 at different directions when the TPA device 116 and the terminal 112 are inserted into the cavity 501, to thereby inhibit unwanted movement of the electrical terminal 112 within the connector housing 114. Specifically, as shown in FIG. 5 and discussed in greater detail below, in various embodiments one or more respective upper or lower bodies 210, 212 of the TPA device 116 are configured to reduce a clearance for the terminal 112 (specifically, in certain embodiments, the terminal body 118 thereof) at a plurality of different directions that are substantially perpendicular to one another (e.g., a vertical direction against a lateral side of the electrical terminal 112 and a horizontal direction against a top of the electrical terminal 112), in order to provide stops for the electrical terminal 112 (e.g., for the terminal body 118) in multiple directions and stability for the electrical terminal 112 against movement. Also as depicted in FIG. 5, in various embodiments the upper body 210 and the lower body 212 of the TPA 116 are held in place by respective upper walls 580 and lower walls 590, respectively, of the base housing 540 that at least partially surround the upper body 210 and the lower body 210, respectively, of the TPA device 116, as shown in FIG. 5.

As noted above, in various embodiments, when the electrical terminal 112 is inserted into the connector, the TPA device 116 does not interfere with the electrical terminal 112. In various embodiments, this allows the electrical terminal 112 to insert into the cavity 401 at a low force. In various embodiments, this may be needed so that the wires do not buckle during terminal insertion. In various embodiments, after the electrical terminal is inserted, seating the TPA device 116 creates a tight fit around the electrical terminal 112. Also in various embodiments, by tightening the fit, the TPA device 116 reduces or eliminates the clearance around the electrical terminal 112 once the TPA device 116 is seated in the final position (e.g., as shown in the Drawings).

As depicted in FIG. 5, in various embodiments the terminal body 118 includes, (i) a first top section 502 that includes an upper surface that extends substantially upward (e.g., substantially vertically, in some embodiments) from a portion of the terminal body 118; (ii) a second top section 504 that includes an upper surface that extends horizontally from the first top section 502 as a top surface of the terminal body 118 (in certain embodiments, the second top section 504 is substantially perpendicular to the first top section 502); and (iii) a third top section 510 that includes an upper surface that extends from the second top section 504 toward the terminal lead 117 in a varied pattern to facilitate movement and/or locking within the connector housing 114; (iv) a first bottom section 512 that includes a lower surface that extends substantially downward (e.g., substantially vertically, in some embodiments) from a portion of the terminal body 118; (v) a second bottom section 514 that includes a lower surface that extends horizontally from the first bottom section 512 as a bottom surface of the terminal body 118; and (vi) a third bottom section 520 that includes a lower surface that extends from the second bottom section 514 toward the terminal lead 117 in a varied pattern to facilitate movement and/or locking within the connector housing 114.

In various embodiments, the TPA device 116′s upper and lower bodies 210, 212 of FIG. 5 both provide reduce a clearance for the terminal body 118 at various different locations and directions, to thereby inhibit movement of the electrical terminal 112 within the cavity 501 (i.e., to thereby inhibit movement of the electrical terminal 112 within the connector housing 114).

Specifically, in various embodiments, the upper body 210 includes a first top surface 522 and a second top surface 524. The first top surface 522 of the upper body 210 extends substantially upward, and is aligned with and parallel to the terminal body first top section 502. Also in various embodiments, the first top surface 522 of the upper body 210 reduces clearance for (and preferably reduces clearance for the entire upper surface of) the terminal body first top section 502.

Also in various embodiments, the second top surface 524 extends horizontally, and is aligned with and parallel to the terminal body second top section 504. Also in various embodiments, the second top surface 524 reduces clearance for (and preferably reduces clearance for the entire upper surface of) the terminal body second top section 504.

In addition, in various embodiments, the lower body 212 includes a first bottom surface 532 and a second bottom surface 534. In various embodiments, the first bottom surface 532 of the lower body 212 extends substantially downward, and is aligned with and parallel to the terminal body first bottom section 512. Also in various embodiments, the first bottom surface 532 reduces clearance for (and preferably reduces clearance for the entire lower surface of) the terminal body first bottom section 512.

In addition, in various embodiments, the second bottom surface 534 of the lower body 212 extends horizontally, and is aligned with and parallel to the terminal body second bottom section 514. Also in various embodiments, the second bottom surface 534 reduces clearance for (and preferably reduces clearance for the entire upper surface of) the terminal body 118 second bottom section 514.

As noted above, in various embodiments, when the electrical terminal 112 is inserted into the connector, the TPA device 116 does not interfere with the electrical terminal 112. In various embodiments, this allows the electrical terminal 112 to insert into the cavity 501 at a low force. In various embodiments, this may be needed so that the wires do not buckle during terminal insertion. In various embodiments, after the electrical terminal is inserted, seating the TPA device 116 creates a tight fit around the electrical terminal 112. Also in various embodiments, by tightening the fit, the TPA device 116 reduces or eliminates the clearance around the electrical terminal 112 once the TPA device 116 is seated in the final position (e.g., as shown in the Drawings).

Also in certain embodiments, the tightened fit of the TPA device 116 provides the ability to detect and/or reject terminals 112 that have not been crimped and/or handled properly and/or that do not meet the intended terminal geometry after crimping. For example, in certain embodiments, this tightened fit of the TPA device 116 will reject a terminal 112 that does not comply with the upper and lower limits of crimped terminal geometry or blade position. In addition, in certain embodiments, the interference between the TPA device 116 and the terminal body 118 will not allow the connector (e.g., the electrical connection system 102) to be assembled. In various embodiments, the tightened fit of the TPA device around the terminal results in a rejection of terminals that do not meet an intended terminal geometry, comprising one or more of the following (among other possible implementations): (i) the TPA device not seating fully or seating partially; (ii) the TPA device requiring excessive force; or (iii) the terminal being forced out of the cavity.

Accordingly, in various embodiments, with the exemplary implementation of the electrical connection system 102 as illustrated in FIG. 5, the upper body 210 of the TPA device 116 provides reduced clearance for the electrical terminal 112 (i.e., the terminal body 118 thereof) at multiple different locations, in multiple different directions, to inhibit unwanted movement of the electrical terminal 112 within the connector housing 114. For example, as depicted in FIG. 5, the upper body 210 provides: (i) vertical reduced clearance for the terminal body 118 via first top surface 522, and adjoining horizontal reduced clearance for the terminal body 118 via second top surface 524. Moreover, the lower body 212 provides: (i) vertical reduced clearance for the terminal body 118 via first bottom surface 532, and adjoining horizontal reduced clearance for the terminal body 118 via second bottom surface 534.

Also in certain embodiments, the upper body 210 comprises a unitary piece that is configured to reduce a clearance for the terminal body 118 at multiple adjoining, substantially perpendicular directions, including (i) a first substantially vertical direction via surface 522; and (ii) a second, adjoining horizontal direction via surface 524. Similarly, also in certain embodiments, the lower body 212 comprises a unitary piece that is configured to reduce a clearance for the terminal body 118 at multiple adjoining, substantially perpendicular directions, including (i) a first substantially vertical direction via surface 532; and (ii) a second, adjoining horizontal direction via surface 534.

The devices, systems, and vehicles thus provide for stabilization of the terminal within the terminal housing, for example by the including of various contact or other reduced clearance locations of the TPA device and the housing with the terminals at multiple different locations and directions. As discussed above, the devices, systems, and vehicles include different examples in which the TPA devices are inserted in a side loaded manner, a top loaded manner, a bottom loaded manner, and a front loaded manner. It will be appreciated that the devices, systems, and vehicles may be implemented in connection with any number of inline connection systems of various types of vehicles, as well as in various other applications in connection with any number of other types of devices or systems that include inline connection systems, in various embodiments.

It will be appreciated that the devices, systems, and vehicles may vary from those depicted in the Figures and described herein. For example, the vehicle 100, the electrical connection system 102, and/or various components thereof may vary from that depicted in FIG. 1 and described in connection therewith, in various embodiments. It will similarly be appreciated that the various examples and implementations of the connection system and components thereof may differ from those depicted in FIGS. 2-5 and/or as described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A connector assembly comprising:
a housing, the housing including one or more walls forming a cavity disposed within the housing and configured to allow passage therethrough; and
a terminal position assurance (TPA) device comprising one or more bodies configured to be disposed within the cavity while a terminal is also disposed within the cavity, the one or more bodies configured to reduce a clearance for the terminal at a plurality of different directions when the TPA device and the terminal are disposed within the cavity, to thereby inhibit unwanted movement of the terminal within the housing;
wherein the TPA, the housing, or both, collectively support a first side of the terminal in addition to a second side of the terminal, opposite the first side, when the terminal and the TPA are disposed within the cavity, and wherein at least one body of the TPA device comprises a unitary piece that includes a first segment extending in a first direction and disposed against a first surface of the terminal when the terminal is disposed within the cavity; a second segment extending from the first segment in a second direction that is perpendicular to the first section, and disposed against a second surface of the terminal that extends from the first surface of the terminal when the terminal is disposed within the cavity; and a third segment extending from the second segment in the first direction, and disposed against a third surface of the terminal that extends from the second surface of the terminal when the terminal is disposed within the cavity.

2.-3. (canceled)

4. The connector assembly of claim 3, wherein the one or more bodies:
provide a stop for the terminal against further lateral movement of the terminal body in the second direction; and
reduce a clearance for the terminal in the first direction that inhibits vertical movement of the terminal.

5. The connector assembly of claim 1, wherein:
the cavity is disposed within a lateral side of the housing, to allow entry of the TPA device and the terminal from the lateral side.

6. The connector assembly of claim 1, wherein:
the cavity is disposed within a top of the housing, to allow entry of the TPA device and the terminal from the top of the housing.

7. The connector assembly of claim 1, wherein:
the cavity is disposed within a bottom of the housing, to allow entry of the TPA and the terminal from the bottom of the housing.

8. The connector assembly of claim 1, wherein the TPA device tightens a fit around the terminal, thereby reducing or eliminating a clearance around the terminal once the TPA is seated in its final position.

9. A connector assembly system comprising:
an electrical terminal;
a housing, the housing including one or more walls forming a cavity disposed within the housing and configured to allow passage therethrough; and
a terminal position assurance (TPA) device comprising one or more bodies configured to be disposed within the cavity while the terminal is also disposed within the cavity, the one or more bodies configured to reduce a clearance for the terminal at a plurality of different directions when the TPA device and the terminal are disposed within the cavity, to thereby inhibit unwanted movement of the terminal within the housing;
wherein the TPA, the housing, or both, collectively support a first side of the terminal in addition to a second side of the terminal, opposite the first side, when the terminal and the TPA are disposed within the cavity, and wherein at least one body of the TPA device comprises a unitary piece that includes a first segment extending in a first direction and disposed against a first surface of the terminal when the terminal is disposed within the cavity; a second segment extending from the first segment in a second direction that is perpendicular to the first section, and disposed against a second surface of the terminal that extends from the first surface of the terminal when the terminal is disposed within the cavity; and a third segment extending from the second segment in the first direction, and disposed against a third surface of the terminal that extends from the second surface of the terminal when the terminal is disposed within the cavity

10. (canceled)

11. The connector assembly system of claim 9, wherein at least one body of the TPA device comprises a unitary piece that is configured to reduce a clearance for the terminal at a first direction, against a top surface of the terminal, and at a second direction, against a side surface of the terminal, when the TPA device and the terminal are disposed within the cavity, to thereby inhibit unwanted movement of the terminal inside the housing.

12. The connector assembly system of claim 9, wherein:
the cavity is disposed within a lateral side of the housing, to allow entry of the TPA device and the terminal from the lateral side.

13. The connector assembly system of claim 9, wherein:
the cavity is disposed within a top of the housing, to allow entry of the TPA device and the terminal from the top of the housing.

14. The connector assembly system of claim 9, wherein:
the cavity is disposed within a bottom of the housing, to allow entry of the TPA device and the terminal from the bottom of the housing.

15. The connector assembly system of claim 9, wherein the TPA device tightens a fit around the terminal, thereby reducing or eliminating a clearance around the terminal once the TPA is seated in its final position.

16. A vehicle comprising:
a vehicle body; and
a connector assembly system disposed within the vehicle body, the connector assembly system comprising:
an electrical terminal;
a housing, the housing including one or more walls forming a cavity disposed within the housing and configured to allow passage therethrough; and
a terminal position assurance (TPA) device comprising one or more bodies configured to be disposed within the cavity while the terminal is also disposed within the cavity, the one or more bodies configured to reduce a clearance for the terminal at a plurality of different directions when the TPA device and the terminal are disposed within the cavity, to thereby inhibit unwanted movement of the terminal within the housing;
wherein the TPA, the housing, or both, collectively support a first side of the terminal in addition to a second side of the terminal, opposite the first side, when the terminal and the TPA are disposed within the cavity, and wherein at least one body of the TPA device comprises a unitary piece that includes a first segment extending in a first direction and disposed against a first surface of the terminal when the terminal is disposed within the cavity; a second segment extending from the first segment in a second direction that is perpendicular to the first section, and disposed against a second surface of the terminal that extends from the first surface of the terminal when the terminal is disposed within the cavity; and a third segment extending from the second segment in the first direction, and disposed against a third surface of the terminal that extends from the second surface of the terminal when the terminal is disposed within the cavity.

17. (canceled)

18. The vehicle of claim 16, wherein at least one body of the TPA device comprises a unitary piece that is configured to reduce a clearance for the terminal at a first direction, against a top of the terminal, and at a second direction, against a side of the terminal, when the TPA device and the terminal are disposed within the cavity, to thereby inhibit unwanted movement of the terminal within the housing.

19. The vehicle of claim 16, wherein:
the TPA device tightens a fit around the terminal, thereby reducing or eliminating a clearance around the terminal once the TPA is seated in its final position; and
the tightened fit of the TPA device around the terminal results in a rejection of terminals that do not meet an intended terminal geometry, comprising one or more of the following: (i) the TPA device not seating fully or seating partially; (ii) the TPA device requiring excessive force; or (iii) the terminal being forced out of the cavity.

20. (canceled)

21. The connector assembly of claim 1, wherein the TPA supports both the first side of the terminal and the second, opposing side of the terminal when the terminal and the TPA are disposed within the cavity.

22. The connector assembly of claim 1, wherein the TPA supports the first side of the terminal, and the housing supports the second, opposing side of the terminal when the terminal and the TPA are disposed within the cavity.

23. The vehicle of claim 16, wherein the TPA supports both the first side of the terminal and the second, opposing side of the terminal when the terminal and the TPA are disposed within the cavity.

24. The vehicle of claim 16, wherein the TPA supports the first side of the terminal, and the housing supports the second, opposing side of the terminal when the terminal and the TPA are disposed within the cavity.

25. The vehicle of claim 16, wherein:
the first segment and the third segment are configured to restrict movement of the terminal in a vertical direction when the terminal is disposed within the cavity; and
the second segment is configured to restrict movement of the terminal in a horizontal direction when the terminal is disposed within the cavity.
